(19) United States
(12) Patent Application Publication
(10) Pub. No.: US 2026/0002796 A1
(43) Pub. Date: Jan. 1, 2026

(54) POSITION SENSING OF MEMS MOVING STRUCTURES

(71) Applicant: Preciseley Microtechnology Corporation, Burnaby (CA)

(72) Inventors: Tiansheng ZHOU, Burnaby (CA); Qiuyang XIONG, Burnaby (CA); Lawrence LAM, Burnaby (CA); Daniel MILDENBERGER, Burnaby (CA); Zhiwei ZHOU, Burnaby (CA)

(21) Appl. No.: 19/301,539

(22) Filed: Aug. 15, 2025

Related U.S. Application Data
(63) Continuation of application No. PCT/CA2024/050232, filed on Feb. 26, 2024.
(60) Provisional application No. 63/448,383, filed on Feb. 27, 2023.

(51) Int. Cl. G01D 5/16; G01D 5/24; G01S 7/481

(52) U.S. Cl. CPC G01D 5/16; G01D 5/24; G01S 7/4817

(57) ABSTRACT

The disclosure pertains to a deflectable micro-mechanical system with integrated piezoresistive deflection sensor, the system comprising, a deflectable element; a first anchor element and a second anchor element, a first spring having a deformable region and coupling the deflectable element to the first anchor element and a second spring that having a deformable region and coupling the deflectable element to the second anchor element. When the relative position of the deflectable element to the anchor element changes, the deformable region of the first spring and the deformable region on the second spring deform. At least one of the first spring and second spring are piezoresistive and the piezo-resistance of the piezoresistive springs changes when the deformable region of the first spring and the deformable region of the second spring deforms. A first contact and a second contact are located on the first anchor element and second anchor element, respectively. The first contact is in electrical connection with the first anchor element and the second contact is in electrical connection with the second anchor element. The first contact and second contact are electrically coupled to a resistance detection circuit configured to detect the overall piezo resistance change of the first spring and second spring and using the piezo resistance change to determine the deflection of the deflectable element.

### RELATED APPLICATION INFORMATION

This application is a continuation of International Application Number PCT/CA2024/050232, filed on Feb. 26, 2024, which claims the benefit of U.S. provisional application. No. 63/448,383, filed on Feb. 27, 2023, which applications are incorporated herein by reference in their entireties.

### TECHNICAL FIELD

The present invention is directed towards the tilting position sensing of MEMS (Micro-Electro-Mechanical systems) structures (such as micromirror) during their operation.

### BACKGROUND

The MEMS (Micro-Electro-Mechanical Systems) mirrors and mirror arrays have wide applications within fiber optic networks in various modules like optical switches, optical attenuators, optical tunable filter etc.

Additionally, MEMS scanning mirrors offer critical light scanning function in the modules of Pico projector, HUD (Head Up Display), AR/VR etc. The MEMS (Micro-Electro-Mechanical Systems) mirrors also have applications in LiDAR (Light Detection and Ranging) for laser beam steering and guiding the returned laser beam to the sensitive detectors.

It is important to obtain the real time information of the scanning or tilting mirror positions in order to achieve the best performances, such as the best resolution and image stability of Pico projector, best detection position and resolution of the LiDAR etc.

Traditionally, bulky and expensive external PSDs (Position sensing detector) were used to interpret the scanning or tilting mirror positions. This approach, however, could not offer effective solutions to the applications such as LiDAR, and AR/VR due to the cost and footprint constraints.

This invention uses on-chip sensing elements to offer real time scanning or tilting mirror position detection with the best cost, size, and performances.

### SUMMARY

This invention describes various on-chip element designs and their combinations that generate real time position information of moving structures in a MEMS device, in this case scanning or tilting MEMS mirror position, with best performance, cost and size. This invention can also offer real time movement sensing of tethered moving structures in other relevant sensor applications.

One embodiment pertains to a deflectable micro-mechanical system with integrated piezoresistive deflection sensor, the system comprising, a deflectable element; a first anchor element and a second anchor element, a first spring having a deformable region and coupling the deflectable element to the first anchor element and a second spring that having a deformable region and coupling the deflectable element to the second anchor element. When the relative position of the deflectable element to the anchor element changes, the deformable region of the first spring and the deformable region on the second spring deform. At least one of the first spring and second spring are piezoresistive and the piezo-resistance of the piezoresistive springs changes when the deformable region of the first spring and the deformable region of the second spring deforms. A first contact and a second contact are located on the first anchor element and second anchor element, respectively. The first contact is in electrical connection with the first anchor element and the second contact is in electrical connection with the second anchor element. The first contact and second contact are electrically coupled to a resistance detection circuit configured to detect the overall piezo resistance change of the first spring and second spring and using the piezo resistance change to determine the deflection of the deflectable element.

### BRIEF DESCRIPTION OF THE DRAWINGS

These and other features will become more apparent from the following description, in which reference is made to the appended drawings. The drawings are for the purpose of illustration only and are not intended to be in any way limiting, wherein:

FIG. 1: Configuration of the MEMS LiDAR system with mirror position feedback control.

FIG. 2a-2d: Illustration of 1-dimensional and 2-dimensional MEMS mirror with hybrid piezo-resistive and another additional mirror position sensing.

FIG. 3: Embodiment of the 1D MEMS tilting mirror with piezo-resistive sensing and capacitive sensing with staggered comb drive design.

FIG. 4a-4c: Diagram of the 1D MEMS tilting mirror capacitive sensing and piezo-resistive sensing mechanism for a type of MEMS mirror design.

FIG. 5: Embodiment of the 1D MEMS tilting mirror with piezo-resistive sensing and capacitive sensing with slanted comb drive design.

FIG. 6a-6b: Diagram of the 1D MEMS tilting mirror capacitive sensing and piezo-resistive sensing mechanism for a type of MEMS mirror design.

FIG. 7: Embodiments of the 1D MEMS tilting mirror with different flexure/piezo-resistor designs.

FIG. 8: Embodiments of the 1D MEMS tilting mirror with different capacitive driving and sensing comb drive designs.

FIG. 9: Embodiment of the 2D MEMS tilting mirror with hybrid piezo-resistive and capacitive sensing for first tilting axis, and capacitive sensing for second tilting axis.

FIG. 10: Breakdown view of the structures with different electrical connections for the 2D MEMS tilting mirror design.

FIG. 11: Embodiment of the 2D MEMS tilting mirror with hybrid piezo-resistive and capacitive sensing for first tilting axis, and independent capacitive sensing comb drive for second tilting axis.

FIG. 12: Embodiment of the 2D MEMS tilting mirror with hybrid piezo-resistive and capacitive sensing for first tilting axis, and hybrid piezo-resistive sensing and capacitive sensing for second titling axis.

FIG. 13: Another embodiment of the 2D MEMS tilting mirror with hybrid piezo-resistive and capacitive sensing for first tilting axis, and hybrid piezo-resistive sensing and capacitive sensing for second titling axis.

FIG. 14: Configuration of the Metal trace deposition on to bulk silicon for connection from electrodes to piezo-resistor structures.

FIG. 15: Embodiments of the piezo-resistive sensing element with single electrical connection from fixed anchor electrode to moving MEMS structure.

FIG. 16: Embodiments of the piezo-resistive sensing element with multiple electrical connections from fixed anchor electrodes to moving MEMS structure.

FIG. 17: Diagram of processing the piezo-resistive and capacitive sensing for the mirror position feedback.

FIG. 18: An embodiment of using piezo-resistive sensing signal and capacitive sensing signal for the mirror position sensing with complementary sensitivity achieved by hybrid sensing.

FIG. 19: An embodiment of using piezo-resistive sensing signal and capacitive sensing signal for the mirror driving control and the mirror position sensing by hybrid sensing.

### DETAILED DESCRIPTION OF THE INVENTION

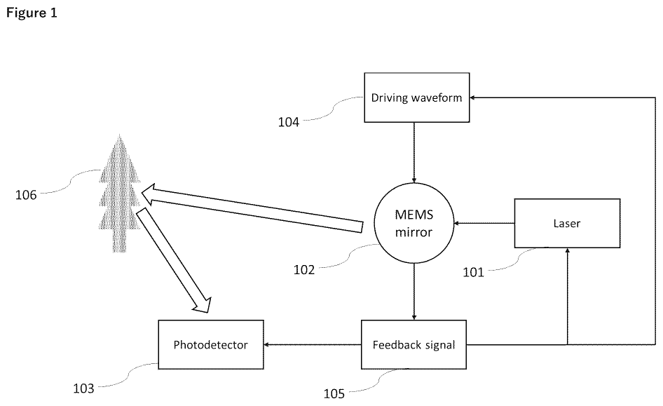

FIG. 1 shows a symmetric diagram of the typical optical LiDAR with Micro-electrical-mechanical-system (MEMS) mirror. The system generally consists of laser source 101, the MEMS mirror scanner 102, the MEMS mirror driver 104, and the photodetector 103. For LiDAR application, the laser beam deflected by the MEMS mirror will propagate and reach the detection target 106 and then the laser beam is scattered and reflected. The reflected signal is detected by the photodetector 103. The MEMS mirror 102 is also able to generate feedback signal 105. Feedback signal is coupled to MEMS mirror driver 104 for real time correction of mirror gesture to achieve optical staring scanning pattern tuning. Feedback signal can also be coupled to 101 to modulate the laser pulse distribution within a scanning cycle. The feedback signal feature is highly sought after in MEMS LiDAR applications for achieving uniform angular resolution, as generating a linear scanning pattern with MEMS mirrors can be challenging. Feedback signal also needs to be coupled with the receiver for synchronization of the cloud point, resolution of detection targets and prevention of pixel shifting caused by environmental change. Similarly, the feedback mechanism is also highly favourable for other applications such as HUD and pico-projector. Previously, there has been a description of MEMS mirrors with sensor feedback. But the feedback is generated with single type of mirror position sensing method, which can either be capacitive sensing, piezo-electric sensing, piezo resistive sensing, electromagnetic induction sensing, or optical sensing etc. In this patent, various MEMS mirror position sensing with hybrid sensing methods are proposed. Moreover, a piezo-resistor design is proposed for the detection of the MEMS mirror position. A specific hybrid sensing combination detailed in this patent is the combination of capacitive sensing and piezo-resistive sensing. Higher detection accuracy and reliability are anticipated with the piezo-resistive-capacitive hybrid (PRCH) sensing method.

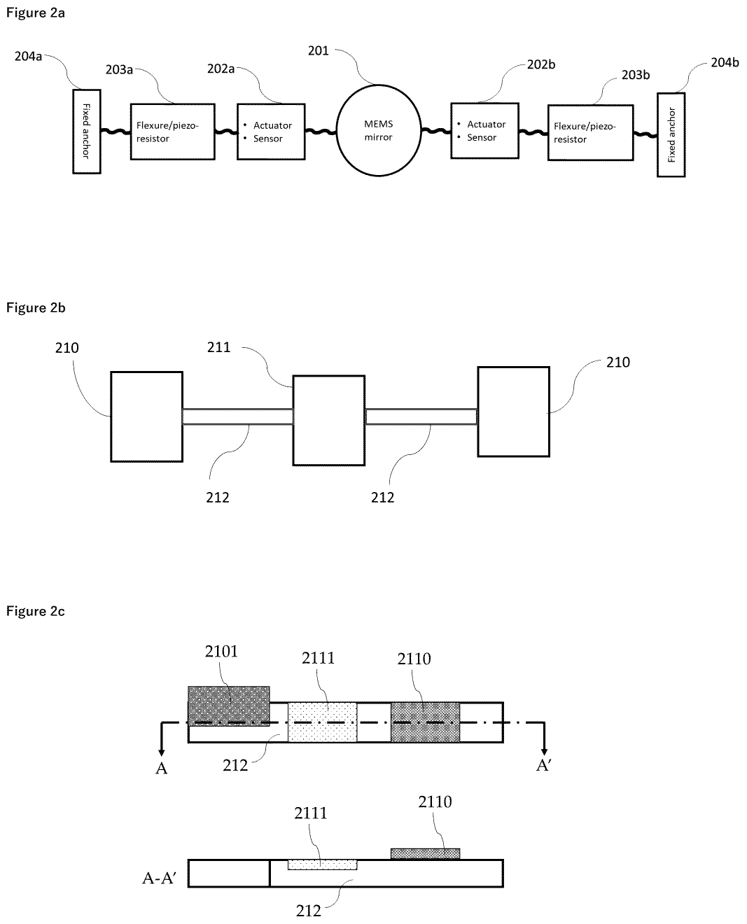

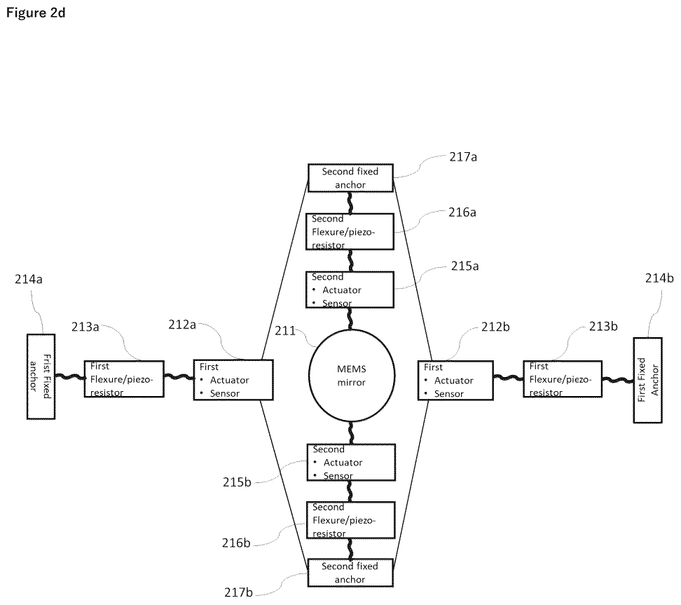

FIGS. 2a, 2b, 2c and 2d shows an embodiment of the 1-dimensional and 2-dimensional tilting MEMS mirror with hybrid tilting angle sensing method, combining a particular sensing method with piezo-resistive sensing. In FIG. 2a, for 1-D tilting MEMS mirror, the design consists of the MEMS mirror 201, the actuator/sensor 202a, 202b, flexure/piezo-resistor 203a, 203b, and the fixed anchor 204a, 204b. The MEMS mirror 201 is used to reflect incident light. The actuator/sensor 202a, 202b are used to move and control the mirror position. The types of the actuators can be electrostatic actuators (in-plane comb drive actuators, staggered comb drive actuators, or parallel plate electrostatic actuators), electrothermal actuators, electromagnetic actuators, or piezo-electrical actuators etc, whichever actuators can convert input driving signal to torsional, transverse, or longitudinal deformation on MEMS structures. For scanning mirror applications, these actuations result in the mirror scanning. The same actuators also offer sensing functions for mirror positions. The driving and sensing structures 202a and 202b can be implemented using the same structure or several separate structures. For example, if electrostatic comb drive actuator is used as an actuator, the same electrostatic comb drive can be also used as a capacitive position sensor. On the other hand, another independent sensing comb drive other than the driving comb drive can be used as a sensor. The 202a and 202b are also coupled/connected to the flexure/hinge 203a and 203b. Since the flexure/hinge 203a and 203b will deform while mirror rotates, the resulting stress and strain of the flexure/hinge can be sensed with the help of piezoresistive sensing elements. These piezoresistive sensing elements can be formed using piezoresistive materials such as doped polysilicon films, or doped silicon or implanted silicon. To achieve good sensing results, the piezoresistive elements must be placed in the high stress region of the flexure/hinge, which introduces process difficulties and reliability issues. For example, misalignment of doping and implantation in the high stress regions on the flexure/hinge structures will generate poor sensing signal. The delamination of the piezoresistive elements/films will also occur due to the high stress of the flexure/hinge structures.

In this invention, we use the flexure/hinge structure itself as the piezoresistive sensing element. In FIG. 2b, 211 is the mirror or any other moving structure subject to actuations. It is supported by 210 through flexure/hinge 212. 210, 211 and 212 are made from doped single crystal silicon. The properly doped silicon has good piezoresistive properties. 211 can be actuated by external shock and vibration, electrostatic actuators (in-plane comb drive actuators, staggered comb drive actuators, or parallel plate electrostatic actuators), electrothermal actuators, electromagnetic actuators, or piezo-electrical actuators etc. The stress and strain will cause a change in electrical resistance of the flexure/hinge. We can use electrical interrogation circuits such as Wheatstone bridge to sense the resistance change and correlate the movement and position of 211. This approach will reduce the process difficulties and improve sensing reliabilities. For example, we do not need to align doping and implantation areas in the high stress regions on the flexure/hinge structures. We can also avoid selective area doping and implantation processes, as well as delamination of the piezo-resistive elements/films.

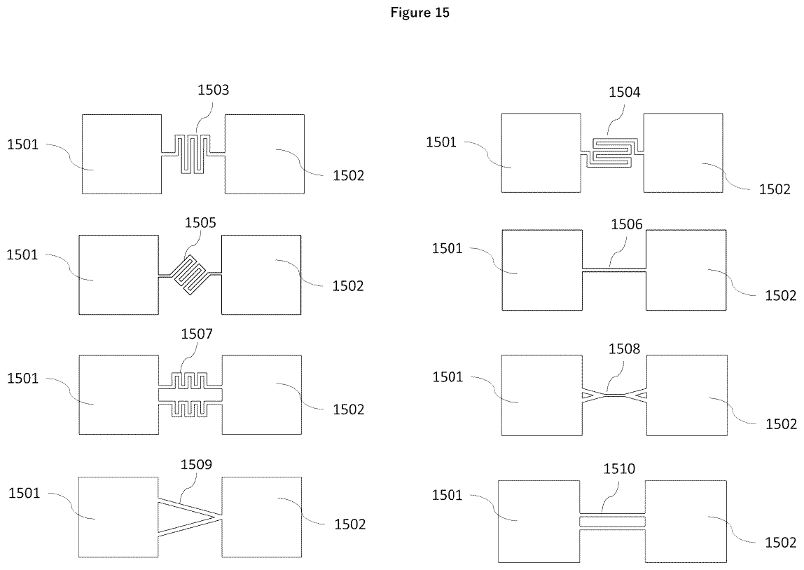

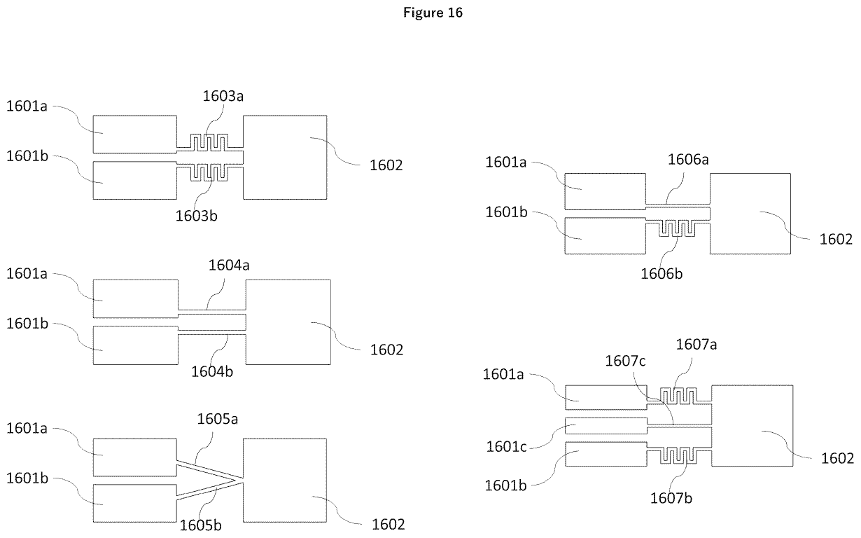

To further improve the piezo-resistive sensitivity of the flexure/hinge and take the best advantage of the stress distribution of the flexure/hinge, structure optimization is implemented. Some structures are shown in FIGS. 15 and 16.

Also, in FIG. 2c, the properly doped single crystal silicon flexure/hinge 212 is coated with conductive film such as metal film 2110 to remove negative effects of piezoresistive sensing of 212. Also, some selective silicon etching 2101 to remove the silicon to remove negative effects of piezoresistive sensing of 212. In addition, some area 211 of the hinge can be doped with certain dopant to change the conductance of the flexure/hinge material. The different doping level will enhance the piezo sensitivity of the material and remove negative effect of different type of stress to piezoresistive sensing of 212.

In FIG. 2d, for the 2-D tilting MEMS mirror, the design consists of the MEMS mirror 211, the first actuator/sensor 212a, 212b and first flexure/piezo-resistor 213a, 213b, the first fixed anchor 214a, 214b designed for the first rotation axis and second actuator/sensor 215a, 215b, second flexure/piezo-resistor 216a, 216b and second fixed anchor 217a, 217b designed for the second rotation axis. The second fixed anchor 217a, 217b are coupled to the first anchor/sensor 212a, 212b, so the entire structure for the second axis rotation can move with the first rotation axis. The arrangement of the actuator/sensor, flexure/piezo-resistor are identical with 1D tilting mirror mentioned above.

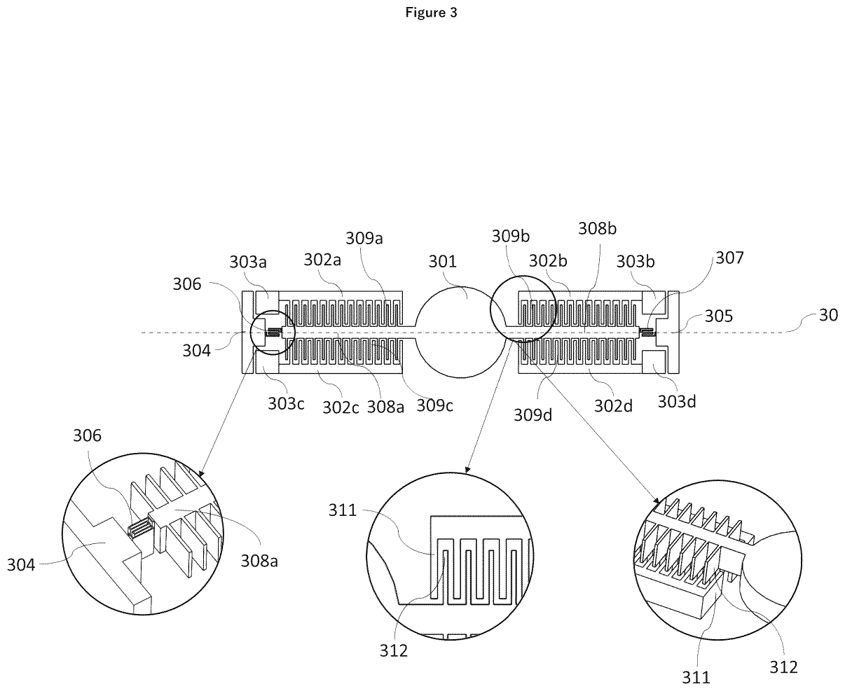

FIG. 3 shows an embodiment of the 1-dimensional tilting MEMS mirror design with feature for PRCH sensing. The structures shown in the figure are fabricated by highly doped silicon (n or p). The design is based on a 1D gimbal structure with electrostatic actuators. The MEMS mirror 301 is coupled to two supporting beams 308a and 308b. The supporting beams 308a and 308b connect the MEMS mirror 301 and the flexure/piezo-resistor 306 and 307. The flexure/piezo-resistor 306 and 307 are for mirror tilting and act as the piezo-resistive sensor of tilting angle. The flexure/piezo-resistor 306 and 307 situates on the rotation axis 30 of MEMS mirror. Meanwhile, the movable comb drive 309a, 309b, 309c and 309d are also coupled to 308a and 308b. The comb drive is distributed on both sides of 308a and 308b beams in the embodiment as shown in the figure. The flexure/piezo-resistor 306 and 307 are connected to the fixed anchor electrode 304 and 305. The flexure/piezo-resistor 306 and 307 are the only connections from the fixed anchor electrode 304 and 305 to the two supporting beams 308a and 308b. 304 and 305 have wire bonding pad on it for external connectivity. The MEMS mirror 301, two supporting beams 308a, 308b, flexure/piezo-resistor 306, 307, and movable comb drive 309a, 309b, 309c, 309d, form the moving part of the MEMS mirror. All movable components are electrically connected due to the high doping level of the silicon, and it is used as the common end for MEMS mirror driving. In this embodiment, a group of 4 fixed comb drives 302a, 302b, 302c, 302d are designed in correspondence with moveable comb drives for actuation purpose. The fixed comb drives 302a, 302b, 302c, 302d are connected to electrode 303a, 303b, 303c, 303d with bonding pads on top to drive individual comb drives. Each of the fixed comb drive is electrically isolated from the common end and other fixed comb drives. A pair of movable comb drive and fixed comb drive forms an electrostatic actuator that drives the mirror to rotate. The staggered vertical comb drive design in use, is as shown in the zoom-in view of the comb drive. The comb fingers for the fixed comb drive 311 and the comb fingers for the movable comb drive 312 are positioned at different heights. In the preferred embodiment shown in FIG. 3, the position of comb fingers for the fixed comb drive 311 is lower than that of the comb fingers for the movable comb drive 312. Other than actuation, the staggered comb drive as a variable capacitor is also used for sensing when mirror rotates. During operation, the common end is connected to the electrical ground and the bias voltage is applied to the fixed comb drives. Either anchor electrode 304 or 305 can be connected to ground and then coupled to the common end through either flexure/piezo-resistor 306 or 307 depending on which side is connected. When voltage is applied, electrostatic force will actuate the comb fingers of the fixed comb drive 311 and the comb fingers of the movable comb drive 312 to move along the vertical direction parallel to the comb finger sidewall. The movement will be coupled to the two supporting beams 308a, 308b, MEMS mirror 301 and the entire movable part of the mirror will tilt along the axis defined by flexure/piezo-resistor 306 and 307. Meanwhile, as the movable part rotates, the capacitance change of the comb drive can be measured between the anchor electrode 304, 305 and electrode 302a, 302b, 302c, 302d. The flexure/piezo-resistor 306 is shown in a detail view in FIG. 3. The flexure/piezo resistor 306 is coupled with 304 and support beam 308a. When support beam 308a rotates, the flexure/piezo resistor 306 deforms to compensate the torsional deformation generated by support beam 308a. The deformation of the flexure/piezo resistor 306 causes stress change and leads to resistance change of flexure/piezo resistor 306. Meanwhile, on the other end of the mirror, the rotation also causes the deformation of flexure/piezo resistor 307 and results in the change of resistance like flexure/piezo resistor 306. The resistance change is detected by measuring the resistance between the anchor electrode 304 and anchor electrode 305. The support beam 308a, MEMS mirror 301, support beam 308b are fabricated with highly doped silicon and their dimensions are much larger compared to flexure/piezo resistor 306 and 307. Thus, the structural resistances of support beam 308a, MEMS mirror 301, and support beam 308b are much smaller compared to flexure/piezo resistors 306 and 307. Meanwhile, the resistance variation is also negligible. Thus, overall piezo-resistance variation, mainly contributed from flexure/piezo resistors 306 and 307, is correlated to the mirror tilting angle.

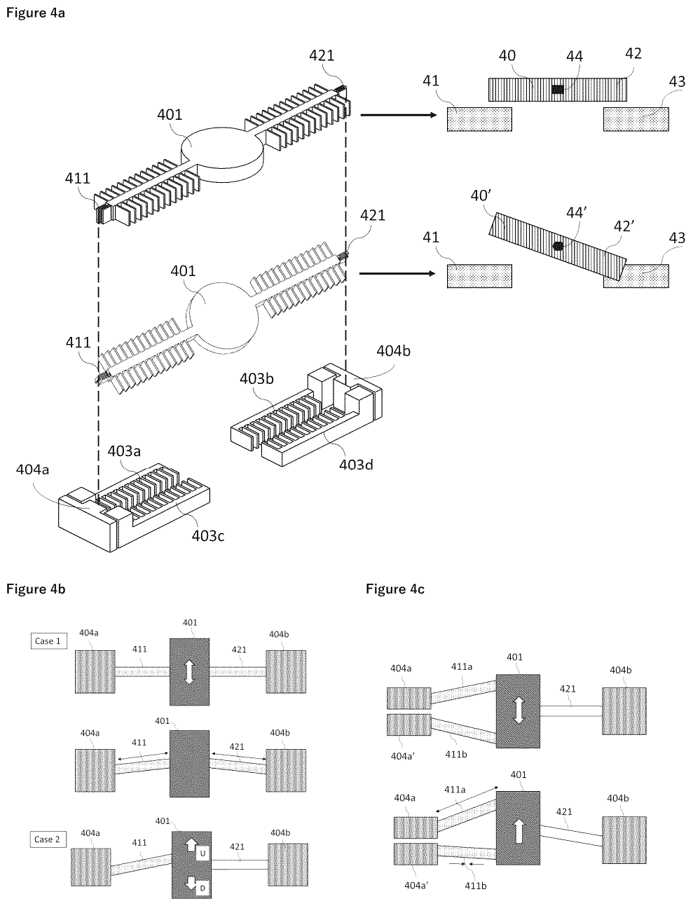

FIG. 4a shows implementation of PRCH sensing with the embodiment proposed in FIG. 3. The structure breakdown view consists of movable part 401, which includes mirror reflector and actuator, flexure/piezo-resistor 411, 421, and fixed part which includes fixed comb drive 403a, 403b, 403c, 403d and fixed anchor electrode 404a and 404b. When OV voltage is applied, the mirror does not move and stays at neutral position 401. At this position, flexure/piezo resistors 411, 421 are under trivial stress due to the weight of movable part. The cross-section of the relative position of the movable comb fingers and the fixed comb fingers are shown in the diagram on side. The fixed lower comb figures are represented by reference characters 41 and 43 and the moveable upper comb fingers are represented by reference characters 40 and 42. The flexure/piezo resistor is represented by reference character 44. The capacitance between fixed lower comb finger 41, 43 to movable upper comb finger 40, 42 stays at a constant value. When the mirror is driven by external signal, the mirror movable part tilts to a second position. In the second position, flexure/piezo-resistors 411 and 421 deform and the piezo-resistor value of flexure/piezo-resistor 411, 421 changes as it is under stress. The cross-section view of tilted mirror is shown in the diagram on side of FIG. 4a. Reference characters 40′ and 42′ represent the movable comb finger positions when mirror tilts to the second position. Reference character 44′ represents the deformed flexure/piezo-resistor when mirror tilts. Comb fingers 42′ and 43 are engaged in this case and generate an overlapping area between the comb fingers. The capacitance between the comb finger varies with the overlapping area of the comb drive. Therefore, the mirror tilting angle can be deduced based on the capacitance value. Meanwhile, piezo-resistor value also changes as flexure/piezo-resistor 44 deforms to 44′. The stress caused by deformation will depend on the tilting angle of the movable structure. Piezo-resistance change can be measured through the electrodes 404a and 404b.

The FIG. 4b shows 2 cases of the piezo sensing flexure/hinge detection for deflection. Reference characters 404a and 404b are the anchors. Reference character 401 is the movable mirror or a proof mass. Reference characters 411 and 421 are hinges connecting the anchors 404a and 404b to the movable mirror 401. The structures are all made with uniformly properly doped silicon. The silicon itself is a piezo-resistive material. When the movable mirror 401 tilts, it will pull the hinge/flexure 411 and 421. As an example, in case 1, hinges 411 and 421 are under pulling when the movable mirror 401 is titling to one side to as shown in the second position. Since both of the hinges are under the tensive stress, the piezo-resistance will change. The hinges 411 and 421 will either both increase or decrease and will provide a constructive response. The lateral shifting of the movable mirror 401 can be caused by intentional applied a in-plane. If the mirror is tilting the other side, both hinges 411 and 421 will also be pulled and cause a tensive stress whereat. The piezo resistive responsibility is identical when movable mirror 401 tilts to both sides. Sometimes, a non-identical or directional information is required in certain applications. As shown in case 2, the hinge 411 is intentionally skewed in design to create an asymmetric geometry about the rotation axis, as shown in the FIG. 4b. when the mirror in the second position shifts in an upward direction (shown by U), the hinge 411 will be under tensile stress. When the mirror in the second position shifts in a downward direction (shown by D), the hinge 421 will be under compressive stress. Thus, the response of the two directions can be distinguished. In this case, the hinge 421 could be non-sensitive to the moveable mirror 401 in a first position depending on the design. Taking advantage of the asymmetric hinge design, the FIG. 4c shows a case with two piezo-sensors placed in to form a detection bridge. Reference characters 404a, 404a′, 404b are the anchors, 401 is the movable mirror or a proof mass. Reference characters 411a, 411b and 421 are the hinges connecting the anchors 404a, 404a′ 404b to the movable mirror 401. The hinge 411a and 411b are piezo-resistance sensing element for the movable mirror 401 in the first position. Hinge 411a is asymmetric about the rotation axis. Hinge 411b is also asymmetric about the rotation axis. In this case, the hinge 421 is non-position sensitive hinge, but provides electrical connection from anchors 404b to movable mirror 401. When the mirror 401 shift to one direction, as shown in the FIG. 4c, the hinge 411a is subject to tensile stress and hinge 411b is subject to compressive stress. The different stress will lead to the increase and decrease of the piezo-resistance of hinges 411a and 411b. The two piezo-resistance elements can thus form a Wheatstone bridge to enhance the responsivity of the position sensing. The sensing circuit can use the hinge 421 as an output of the bridge.

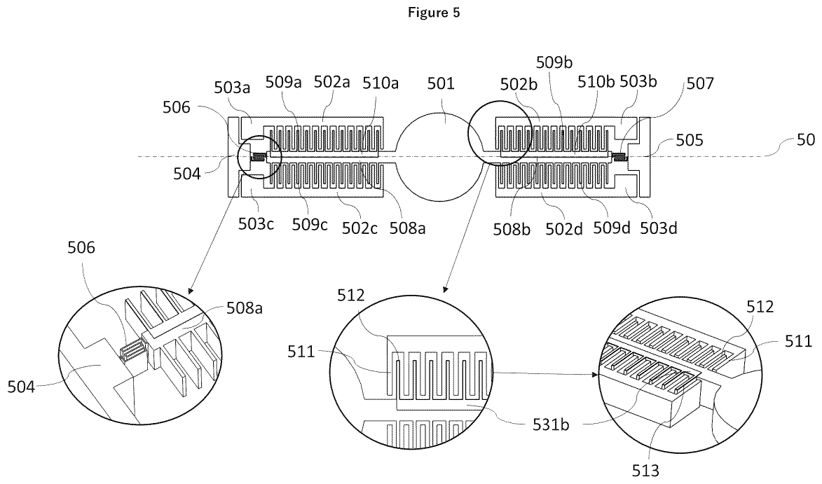

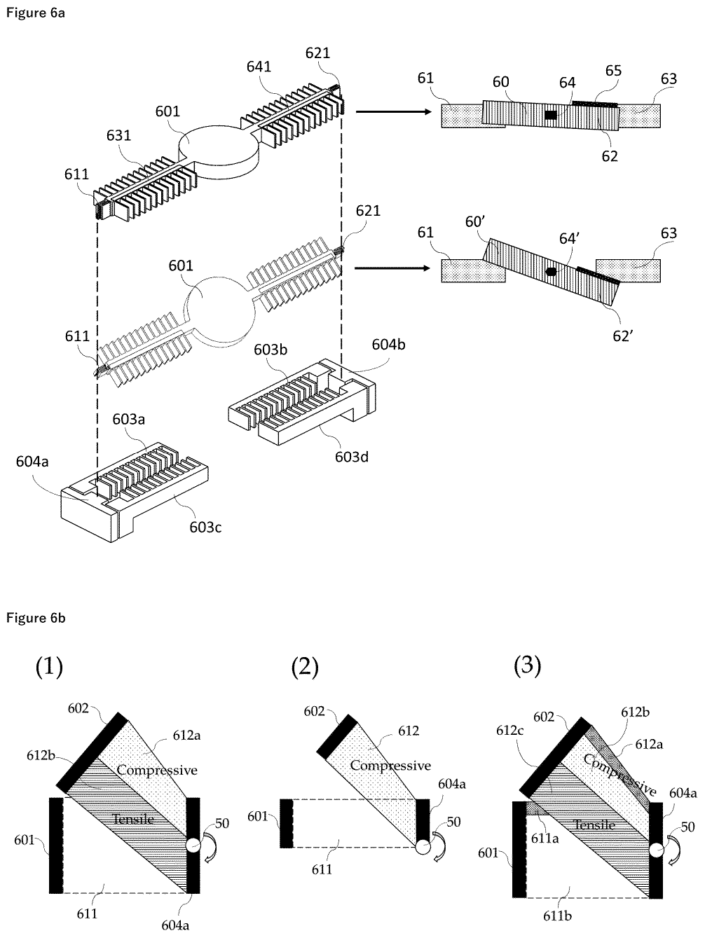

FIG. 5 shows another embodiment of the 1-dimensional tilting MEMS mirror design with PRCH sensing feature. The structures shown in the figure are fabricated by highly doped silicon (n or p). The design is based on a 1D gimbal structure with electrostatic actuators. The MEMS mirror 501 is coupled to two supporting beams 508a and 508b. The supporting beams 508a and 508b connect mirror 501 and the flexure/piezo-resistor 506 and 507. Flexure/piezo-resistors 506 and 507 are the hinges for mirror tilting and also piezo-resistive sensors of tilting angle. Flexure/piezo-resistor 506 and 507 is situated on the rotation axis 50 of the MEMS mirror. Meanwhile, the movable comb drive 509a, 509b, 509c and 509d are also coupled to support beams 508a and 508b. The comb drive is distributed on both sides of support beams 508a and 508b in the embodiment as shown in the figure. Flexure/piezo-resistors 506 and 507 are connected to the fixed anchor electrode 504 and 505. Flexure/piezo-resistors 506 and 507 are the only connections from fixed anchor electrodes 504 and 505 to support beams 508a, 508b and mirror 501. Fixed anchor electrodes 504 and 505 have a wire bonding pad on it for external connectivity. On the top of support beams 508a, 508b and movable comb drive 509a, 509b, an extra layer 510a and 510b are deposited. The deposited material could be metal, dielectric, poly-Si etc. and it causes a weight difference on the symmetric movable comb drive 509a-509c and 509b-509d. The mirror 501, support beams 508a, 508b, flexure/piezo-resistors 506, 507, symmetric movable comb drive 509a, 509b, 509c, 509d, and extra layer 510a, 510b form the moving part of the MEMS mirror. All movable components are electrically connected due to the high doping level of the silicon, and it is used as the common end for MEMS mirror driving. In this embodiment, a group of 4 fixed comb drives 502a, 502b, 502c, 502d are designed in correspondence with moveable comb drives for actuation purpose. Fixed comb drives 502a, 502b, 502c, 502d are connected to electrodes 503a, 503b, 503c, 503d with bonding pad on top to drive individual comb drives. Each of the fixed comb drive is electrically isolated from the common end and other fixed comb drives. A pair of movable comb drive and fixed comb drive form an electrostatic actuator that drives the mirror to rotate. The slanted vertical comb drive design in use is as shown in the zoom-in view of the comb drive. Reference character 511 is a fixed comb finger. Reference characters 512 and 513 are both movable comb fingers but 513 has deposition layer on the top. The deposition layer 531b induces a weight difference, causing 513 to sink and 512 to rise, as 513 and 512 are situated on opposite sides of the movable part's rotation axis. Therefore, the comb finger plane of 512, 513 and the comb finger plane of 511 are separated by a small angle. Fixed comb fingers 513 will be lower than movable comb fingers 511 and movable comb fingers 512 will higher than fixed comb fingers 511. Other than actuation, the slanted comb drive as a variable capacitor is also used for sensing when mirror rotates. During operation, the common end is connected to the electrical ground and the bias voltage is applied to the fixed comb drives. Either fixed anchor electrode 504 or 505 can be connected to the ground and then coupled to the common end through either flexure/piezo-resistor 506 or 507 depending on which side is connected. When driving waveform is applied, electrostatic force will actuate movable comb fingers 512 and fixed comb fingers 513 to move the movable comb fingers 212 along the vertical direction that is parallel to the comb finger sidewall. The movement will be coupled to the support beams 508a, 508b, mirror 501 and the entire movable part of the mirror will tilt along the axis defined by flexure/piezo-resistors 506 and 507. Meanwhile, as the movable part rotates, the capacitance change of the comb drive can be measured between the electrode 504, 505 and electrode 502a, 502b, 502c, 502d. The flexure/piezo-resistor 506 is shown in zoom-in view. 506 is coupled with 504 and 508a. When support beam 508a rotates, flexure/piezo-resistor 506 deforms to compensate the torsional deformation generated by support beam 508a. The deformation of flexure/piezo-resistor 506 causes stress change and leads to resistance change of flexure/piezo-resistor 506. Meanwhile, on the other end of the mirror, the rotation also causes the deformation of flexure/piezo-resistor 507 and results in the change of resistance like flexure/piezo-resistor 506. The resistance change is detected by measuring the resistance between the electrode 504 and electrode 505. The support beam 508a, mirror 501, support beam 508b are fabricated with highly doped silicon, and their dimensions are much larger compared to flexure/piezo-resistors 506 and 507. Thus, the resistances of support beam 508a, mirror 501, and support beam 508b are much smaller compared to flexure/piezo-resistors 506 and 507. Meanwhile the resistance variation is also negligible. The overall piezo-resistance variation mainly contributed from flexure/piezo-resistors 506 and 507 is correlated to the mirror tilting angle.

FIG. 6a shows the process of PRCH sensing with the embodiment proposed in FIG. 5 and slanted comb drive design. The structure breakdown view consists of movable part 601 which includes mirror reflector and actuator, flexure/piezo-resistor 611, 621, fixed part which includes fixed comb drive 603a, 603b, 603c, 603d and fixed anchor structure 604a and 604b. Extra deposition layers 631 and 641 are deposited on the top of single side of the movable comb. When OV voltage is applied, the mirror does not move and stay at neutral position 601. 611, 621 are under trivial stress due to the weight of movable part. The cross-section of the relative position of the movable comb fingers and the fixed comb fingers is shown in the diagram on side. Reference characters 61 and 63 are the fixed comb fingers and reference characters 60 and 62 are the movable fingers. Reference character 64 is the flexure/piezo resistor. The comb finger is tilted to the very small angle at neutral position due to the extra deposition layer 65 on one side of the comb. The movable comb and fixed comb are fully engaged at the neutral position and the capacitance between the combs are maximum at this position. When the mirror is driven by external signal, the mirror movable part tilts to a second position as shown in the middle portion of FIG. 6a. The flexure/piezo-resistors 611 and 621 deform and the piezo-resistor value of flexure/piezo-resistors 611 and 621 change as it they under stress. The cross-section view of tilted mirror is shown in the diagram on side. Reference characters 60′ and 62′ are the movable comb fingers when the mirror tilts. Reference characters 64′ is the deformed flexure/piezo-resistor when mirror tilts. Comb finger 62′ and 63 gradually disengage as the tilting angle increases. The capacitance between the comb finger varies with the overlapping area of the comb drive in vertical direction. Therefore, the capacitance value can be correlated to the mirror tilting angle. Meanwhile, piezo-resistor value also changes as the mirror tilts and flexure/piezo-resistor 64 deforms to 64′. The stress caused by deformation will depend on the tilting angle of the movable structure. Piezo-resistance change can be measured through the bonding pad on 604a and 604b.

The FIG. 6b shows a case of the piezo sensing flexure/hinge for the rotation detection. The (1) of FIG. 6b illustrates a hinge structure sideview. In this case, the 604a is end of the hinge/flexure connected to anchor. The 601 is the end of hinge/flexure connected to the movable part when there is no rotation. 611 is the hinge/flexure when there is no rotation, and it is stress neutral. The hinge structure is made with properly doped silicon, which is piezo-resistive. Reference characters 50 is the rotation axis and the axis is at the middle of hinge 604a in this case. When the movable object rotates, the hinge 604a will remain the same as it is completed anchored. Mirror 601 will rotate to the second position in the figure. When the mirror 601 rotates, only the position changes but the configuration of the mirror 601 should not change as it is situated on a solid piece of movable object, a bulk material. Meanwhile, hinge 611 will deform with the rotation. It can be calculated that the stress distribution on the hinge will divide into compressive and tensile types. 612a represents the part of hinge with compressive stress. 612b represents the part of hinge with tensile stress. However, as the compressive and tensile stress on most occasions will lead to opposite response of piezo-resistance change, the piezo-response is weakened as the impact of different stress cancel out. There are different ways to increase the piezo sensitivity to deflection. In (2) of FIG. 6b, the hinge is selected removed. In this case, the hinge is reduced by half compared with the case in (1). The new hinge is only half height, but other configuration remains the same. In this case, the rotation axis 50 is at the bottom of the 604a. when the movable object rotates, mirror 601 will rotate to the second position and compressive stress will be the dominant factor that affects the piezo resistance of the hinge. Thus, the piezo-response sensitivity is higher compared with the case in (1) as there is much less cancelling effect due different stress types. The (3) of FIG. 6b shows another way to reduce the negative impact of different stress caused cancelling. In this case, the majority of hinge is low dopped p type silicon region 611b. But there is a higher doping level layer on the top of the hinge which is 611a. When the hinge rotates, the stress distribution on the hinge will be divide into compressive region 612b and tensile region 612c similar to case in (1). In this case, the higher doping level region 612a all fall within the compressive stress region 612b. When external circuit is established to detect the piezo-resistance change the hinge/flexure, the current flow will mostly concentrated in the higher doping level region 612a due to higher conductivity. The effect of the compressive stress to the piezo-sensing will be much more dominant compared to tensile. As a result, the cancelling effect due to different type of stress is minimized.

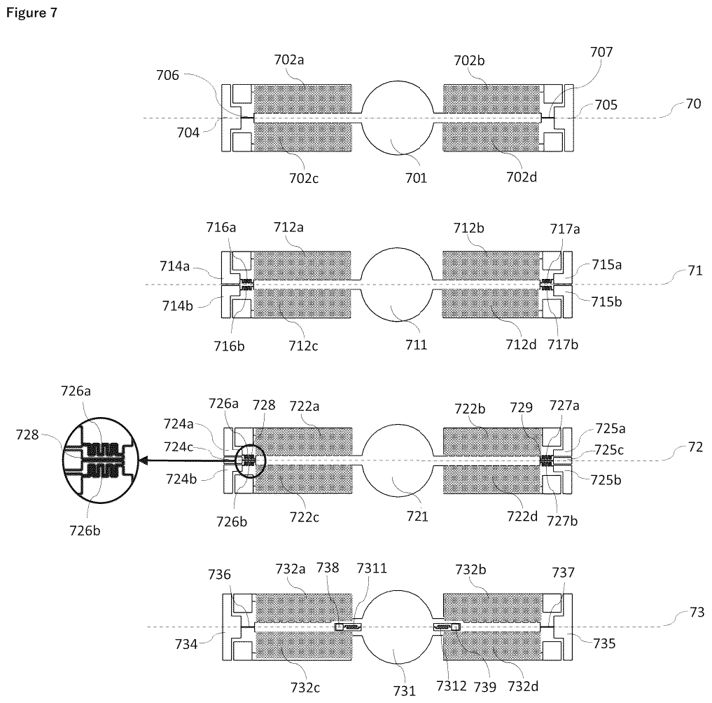

FIG. 7 shows 4 more embodiments of the 1-dimensional tilting MEMS mirror with different flexure/piezo-resistor for PRCH sensing. In the first embodiment, the flexure/piezo-resistor are straight beams 706 and 707. Flexure/piezo-resistors 706 and 707 define the rotation axis 70 of the MEMS mirror. Flexure/piezo-resistor 706 is coupled to movable part 701 and fixed anchor structure 704. Flexure/piezo-resistor 707 is coupled to movable part 701 and fixed anchor electrode 705. Flexure/piezo-resistors 706 and 707 are the only connections from fixed anchor electrodes 704 and 705 to movable part 701. Moveable part 701 is the electrical common end of all flexure/piezo-resistors. There are bonding pads on fixed anchor electrodes 704, 705 for external electrical connections. The piezo-resistance is measured from fixed anchor electrodes 704 to 705. Reference characters 702a, 702b, 702c, 702d are the vertical comb drive actuators, which can be either staggered comb drive design or slanted comb drive design as depicted in embodiments shown in FIG. 3 and FIG. 5. Other structures in the embodiment are identical to embodiments in FIG. 3 and FIG. 5. The mechanisms of driving and PRCH sensing of this embodiment are identical to embodiments in FIG. 3 and FIG. 5.

In the second embodiment, the flexure/piezo-resistor on each end comprise a pair of structures 716a, 716b on one end and 717a, 717b on the other. The pair of structures 716a-716b and pair of structures 717a-717b define the rotation axis 71. Pair of structures 716a, 716b and pair of structures 717a, 717b are distributed on the opposite sides of the rotation axis 71. Structure 716a is coupled to movable part 711 and fixed anchor electrode 714a. Structure 716b is coupled to movable part 711 and fixed anchor electrode 714b. Structure 717a is coupled to movable part 711 and fixed anchor electrode 715a. Structure 717b is coupled to movable part 711 and fixed anchor electrode 715b. Pair of structures 716a and 716b are the only connections from fixed anchor electrodes 714a and 714b to movable part 711. Pair of structures 717a and 717b are the only connections from fixed anchor electrodes 715a and 715b to movable part 711. Movable part 711 is the electrical common end of all flexures/piezo-resistors. There are bonding pads on the fixed anchor electrodes 714a, 714b, 715a, 715b for external electrical connections. Reference characters 712a, 712b, 712c, 712d are the vertical comb drive actuators, which can be either staggered comb drive design or slanted comb drive design as depicted in embodiment shown in FIG. 3 and FIG. 5. Other structures are identical to embodiment in FIG. 3 and FIG. 5. The mechanisms of capacitive sensing of the embodiment are identical to embodiments in FIG. 3 and FIG. 5. Meanwhile, the piezo-resistance is measured from any combination of pair of structures 716a, 716b, pair of structures 717a, 717b through fixed anchor electrodes 714a, 714b, 715a, 715b as all 4 flexure/piezo-resistors are subject to deformation when 711 rotates. Single or multiple flexure/piezo-resistor can be used for the tilting angle sensing. For example, in one case, the resistance of pair of structures 716a-716b is measured through fixed anchors 714a and 714b for the mirror tilting angle sensing. In another case, the resistance of pair of structures 716a-716b and pair of structures 717a-717b are measured through fixed anchor electrodes 714a, 714b and fixed anchor electrodes 715a, 715b respectively for mirror tilting angle sensing.

In the third embodiment, the flexure/piezo-resistor on each end comprise 3 structures in parallel, 726a, 726b, 728 on one end and 727a, 727b, 729 on the other. The zoom in view shows more details. Reference characters 728 and 729 are the main flexures/piezo-resistors that support the rotation of the MEMS mirror and define the rotation axis 72. Reference characters 726a, 726b, are the supporting flexures/piezo-resistors distributed beside the main flexures/piezo-resistor 728. Reference characters 727a, 727b, are the supporting piezo structures distributed beside the main flexures/piezo-resistor 729. Supporting flexures/piezo-resistor 726a is coupled to movable part 721 and fixed anchor electrode 724a. Supporting flexures/piezo-resistor 726b is coupled to movable part 721 and fixed anchor electrode 724b. Supporting flexures/piezo-resistor 727a is coupled to movable part 721 and fixed anchor electrode 725a. supporting flexures/piezo-resistor 727b is coupled to movable part 721 and fixed anchor electrode 725b. Main flexures/piezo-resistor 728 is coupled to moveable part 721 and fixed anchor electrode 724c. Main flexures/piezo-resistor 729 is coupled to movable part 721 and fixed anchor electrode supporting flexures/piezo-resistors 725c. Supporting flexures/piezo-resistors 726a, 726b, and main flexures/piezo-resistor 728 are the only connections from fixed anchor electrodes 724a, 724b, 724c to movable part 721. Supporting flexures/piezo-resistor 727a, 727b, and main flexures/piezo-resistor 729 are the only connections from fixed anchor electrodes 725a, 725b, 725c to movable part 721. Movable part 721 is the common end of all flexures/piezo-resistors. There are bonding pads on fixed anchor electrodes 724a, 724b, 724c, 725a, 725b, 725c for external electrical connections. Reference characters 722a, 722b, 722c, 722d are the vertical comb drive actuators, which can be either staggered comb drive design or slanted comb drive design as depicted in embodiment shown in FIG. 3 and FIG. 5. Other structures are identical to embodiment in FIG. 3 and FIG. 5. The mechanism of capacitive sensing of this embodiment is identical to the embodiment in FIG. 3 and FIG. 5. Meanwhile, the piezo-resistance is measured from any combination pair of supporting flexures/piezo-resistors 726a, 726b, 727a, 727b, and main flexures/piezo-resistors 728, 729 through fixed anchor electrodes 724a, 724b, 725a, 725b, 724c, 725c, as all the 6 flexures/piezo-resistors are subject to deformation as movable part 721 rotates. Single pair or multiple flexure/piezo-resistor pairs can be used for the tilting angle sensing. For example, in one case, the resistance of supporting flexures/piezo-resistors 726a-726b can be measured through fixed anchor electrodes 724a and 724b for the mirror tilting angle sensing. In another case, the resistance of supporting flexures/piezo-resistors 726a-726b and supporting flexures/piezo-resistors 725a-725b can be measured through fixed anchors 724a-724b and fixed anchors 725a-725b respectively for mirror tilting angle sensing. In another case, the resistance of flexures/piezo-resistors 726a-728 and flexures/piezo-resistors 726b-728 can be measured through fixed anchors 724a-724c and 724b-724c for the mirror tilting angle sensing.

In the fourth embodiment, flexure/piezo-resistor on each end comprise a pair of structures 736, 7311 on one end and 737, 7312 on the other. All structures 736, 7311, 737, 7312 are on a straight line which defines the rotation axis 73 of MEMS mirror. Structures 736, 7311, 737, 7312 coincide with rotation axis 71. Structure 736 is coupled to movable part 731 and fixed anchor electrode 734. Structure 737 is coupled to movable part 711 and fixed anchor electrode 735. Structure 7311 is coupled to movable part 731 and fixed anchor electrode 738. Structure 7312 is coupled to movable part 731 and fixed anchor electrode 739. The structures 736, 737, 7311, 7312 are the only connections from fixed anchors electrodes 734, 735, 738, 739 to movable part 731. Movable part 731 is the electrical common end of all flexures/piezo-resistors. There are bonding pads on 734, 735, 738, 739 for external electrical connections. Reference characters 732a, 732b, 732c, 732d are the vertical comb drive actuators, which can be either staggered comb drive design or slanted comb drive design as depicted in embodiment shown in FIG. 3 and FIG. 5. Other structures are identical to embodiment in FIG. 3 and FIG. 5. The mechanism of capacitive sensing of the embodiment is identical to embodiment in FIG. 3 and FIG. 5. Meanwhile, the piezo-resistance is measured from any combination pair of structures 736, 737, 7311, 7312 through fixed anchors 734, 735, 738, 739 as all 4 flexure/piezo-resistors are subject to deformation when movable part 731 rotates. Single or multiple flexure/piezo-resistors can be used for the tilting angle sensing. For example, in one case, the resistance of structures 7311-7312 pair can be measured through the anchors 738 and 739 for the mirror tilting angle sensing. In another case, the resistance of the 7311-736 pair and the 7312-737 pair can be measured through anchors 738, 734 and 739, 735 respectively for mirror tilting angle sensing.

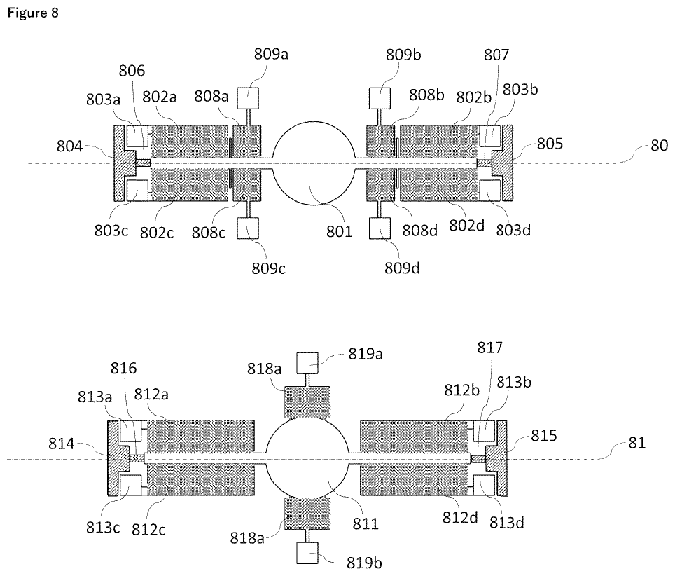

FIG. 8 shows 2 more embodiments of the 1-dimensional tilting MEMS mirror with different driving and sensing comb drive design for PRCH sensing. In the first embodiment, 4 more independent comb drives for sensing are placed beside the fixed driving comb drives in the design. Reference character 801 is the movable part including MEMS mirror and movable frame and can rotate along the axis 80. Movable part 801 is the electrical common end of the device and it couples to electrodes 804 and 805 through flexure/piezo-resistor 806 and 807. Reference characters 802a, 802b 802c, 802d are the driving comb drives designed for mirror actuation, the fixed comb drives of which are coupled to bonding pad structures 803a, 803b, 803c, 803d for external driving signal connections and the movable comb drives of which are coupled to MEMS mirror movable part 801 as a common end. Reference characters 808a, 808b, 808c, 808d are the extended comb drives for the mirror tilting angle sensing, the fixed comb drives of which are coupled to electrodes 809a, 809b, 809c 809d for external sensing signal connections and the movable comb drives of which are placed beside the movable comb of the driving comb drives. The comb drive for driving and sensing can be either staggered comb drive design or slanted comb drive design as depicted in embodiment shown in FIG. 3 and FIG. 5. The flexure/piezo-resistors 806 and 807 may comprise single or multiple flexure structures as depicted in embodiments in FIG. 7. Electrodes 804 and 805 may comprise single or multiple structures as depicted in embodiments in FIG. 7. Other structures are identical to embodiment in FIG. 3 and FIG. 5. As for sensing, the mechanism of the capacitive sensing is the same as embodiments in FIG. 4 and FIG. 6 except for that the capacitance sensing signal is measured between electrodes 809a, 809b, 809c, 809d and electrodes 804, 805. The mechanism of the piezo-resistor sensing is the same as embodiments in FIG. 4, FIG. 6 and FIG. 7.

In the second embodiment, 2 more independent sensing comb drives are placed beside the MEMS mirror in the design. Reference character 811 is the movable part including MEMS mirror and movable frame and can rotate along the axis 81. Movable part 811 is the electrical common end of the device and it couples to electrodes 814 and 815 through flexure/piezo-resistor 816 and 817. Reference characters 812a, 812b 812c, 812d are the driving comb drives designed for mirror actuation, the fixed comb drives of which are coupled to bonding pad structure 813a, 813b, 813c, 813d for external driving signal connection and the movable comb drives of which are coupled to MEMS mirror movable part 811 as a common end. Reference characters 818a, 818b are the additional comb drives for the mirror tilting angle sensing, the fixed comb drives of which are coupled to electrodes 819a, 819b for external sensing signal connections and the movable comb drives of which are coupled to movable part 811 situated beside the MEMS mirror. The comb drive for driving and sensing can be either staggered comb drive design or slanted comb drive design as depicted in embodiments shown in FIG. 3 and FIG. 5. The flexures/piezo-resistors 816 and 817 may comprise single or multiple flexure structures as depicted in embodiments in FIG. 7. Electrodes 814 and 815 may comprise single or multiple structures as depicted in embodiments in FIG. 7. Other structures are identical to embodiments in FIG. 3 and FIG. 5. As for sensing, the mechanism of the capacitive sensing is the same as embodiments in FIG. 4 and FIG. 6 except for that the capacitance sensing signal is measured between 819a, 819b and electrodes 814, 815. The mechanism of the piezo-resistor sensing is the same as embodiments in FIG. 4, FIG. 6 and FIG. 7.

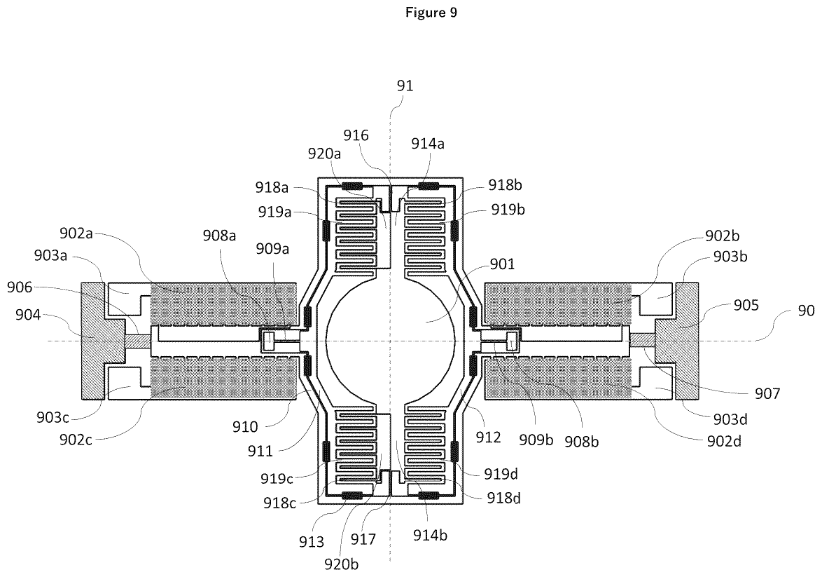

FIG. 9 shows an embodiment of the 2-dimensional tilting MEMS mirror with PRCH sensing implemented on one rotation axis and capacitive sensing implemented on the other axis. The structures shown in the figure are fabricated by highly doped silicon (n or p). The design is based on a 2D gimbal structure with electrostatic actuators. There are two rotation axes for the mirror 901, which are the first rotation axis 90 and the second rotation axis 91. For the first axis 90, the driving and sensing structures and operation mechanisms are identical with the 1D tilting MEMS mirror with PRCH sensing. Reference characters 906 and 907 are the flexures/piezo-resistors for mirror rotation and piezo-resistive angle sensing of axis 90, The flexure/piezo-resistor design and piezo-resistor sensing mechanisms can be identical with either embodiment shown in FIG. 3, FIG. 5, FIG. 7. Reference characters 904, 905 are the fixed anchor electrode for piezo-resistors 906 and 907. The fixed anchor electrode design can be identical with either embodiment shown in FIG. 3, FIG. 5, FIG. 7. Reference characters 902a, 902b, 902c, 902d are driving and sensing comb drives for the axis 90, which can be either staggered comb drive design or slanted comb drive design, independent or integrated sensing comb drive design as depicted in embodiment shown in FIG. 3, FIG. 5 and FIG. 8. Reference character 910 is the frame that provide mechanical support to all movable parts rotating around axis 90. The gimbal rotates along the second rotation axis 91 is imposed on frame 910. Reference characters 916, 917 are the flexures that support rotation around 91. One end of flexures 916, 917 is coupled to frame 910 and the other end is coupled to the supporting beam 914a and 914b which are further coupled to the MEMS mirror 901. The slanted comb drive is designed for the driving and sensing of the rotation axis 91. Reference characters 918a, 918b, 918c, 918d are the movable comb drives for axis 91 which are coupled to supporting beams 914a and 914b. An extra layer 920a and 920b are deposited on the top of comb 918a and 918c. Reference characters 919a, 919b, 919c, 919d are the fixed comb driving the rotation around axis 91. Combs 919a, 919c are coupled to the inner frame 911 and combs 919b, 919d are coupled to inner frame 912 for different tilting direction. The frames 911 and 912 are designed to give mechanical support and electrical connection to the fixed combs 919a, 919b, 919c, 919d. Frame 911 is coupled to the flexure 909a and then to fixed anchor electrode 908a. Frame 912 is coupled to the flexure 909b and then to fixed anchor electrode 908b. 909a and 909b are situated on axis 90 and there are bonding pads on the electrodes 908a and 908b. Frames 911 and 912 are both electrically isolated but mechanically coupled to frame 910 with bonding structure 913. Bonding structure 913 is a bonding structure that is designed to mechanically bond but electrically isolate different parts. There are several bonding structures identical to bonding structure 913 placed between frames 911 and 910, 912 and 910 as shown in the figures. Mirror 901, support beams 914a, 914b, and combs 918a, 918b, 918c, 918d form the movable part that rotates around the rotation axis 91 and the entire axis 91 movable part is coupled to the frame 910 through flexures 916 and 917. As the flexures 916 and 917 only support the mirror rotation around 91 and restrict the rotation otherwise, the entire structure coupled to frame 910 will follow the movement of frame 910 when it rotates around 90. Regarding the rotation around 91, mirror 901, support beams 914a, 914b, flexures 916, 917, and combs 918a, 918b, 918c, 918d form the movable part that rotates around 91 and at the meantime they can also rotate around 90 with frame 910. Meanwhile, they are electrically coupled to the common end through flexures 916 and 917. When driving signal is applied to electrodes 908a, 908b, this signal is transmitted to the fixed comb drives 919a, 919b, 919c, 919d through the flexure 909a, 909b and the inner frames 911, 912 as they are all made of conductively doped Silicon. The movable comb drives 918a, 918b, 918c, 918d are coupled to the common end which is connected to ground. The driving and capacitive sensing mechanism of the rotation axis 91 based on the slanted comb drive is identical to that described in the embodiment in FIG. 5. The mirror rotation around the axes 90 and 91 are decoupled and does not interfere with each other during 2 axes rotation.

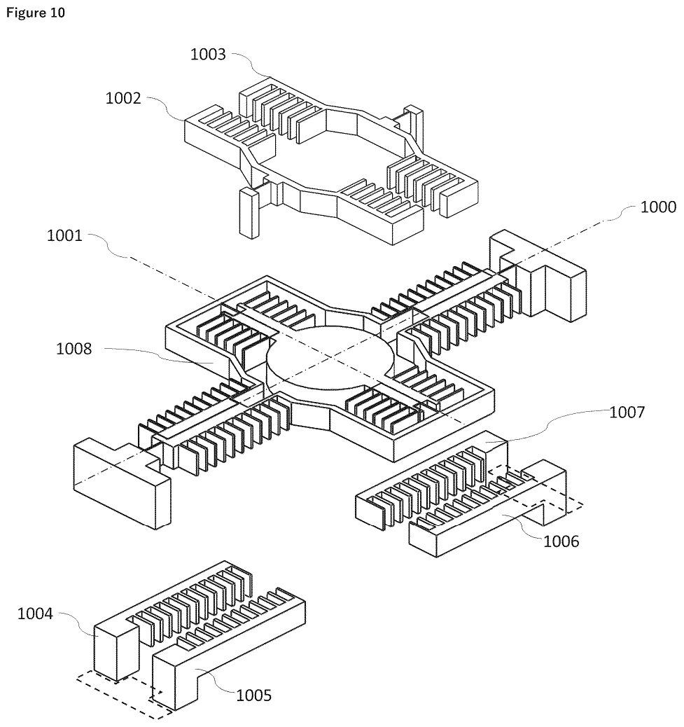

FIG. 10 shows a breakdown view of the 2D MEMS mirror embodiment shown in FIG. 9 with structures separated by electrical connections. In this example, the slanted comb drives identical to embodiment shown in FIG. 5 for both axes are illustrated. The entire structure 1008 is the common end of the device which is connected to ground during operation. The parts include the movable combs of the drives for different axes, the mirror, and frames. Reference characters 1002 and 1003 are the fixed comb of comb drives for axis 1001. Fixed comb drives 1002, 1003 are separated for different tilting directions, clockwise and anti-clockwise. Driving signal and sensing signal is connected to fixed comb drives 1002, 1003 during operation. Both fixed comb drives 1002 and 1003 are mechanically bonded to frame 1008. Reference characters 1004, 1005, 1006, 1007 are the fixed comb for comb drives for axis 1000. Fixed comb drives 1004 and 1007 are a pair of comb drives for the driving of either clockwise or anti-clockwise. Fixed comb drives 1005 and 1006 are a pair of comb drives for the other rotation direction. Driving signal and sensing signal is connected to fixed comb drives 1004, 1005, 1006, 1007 during operation.

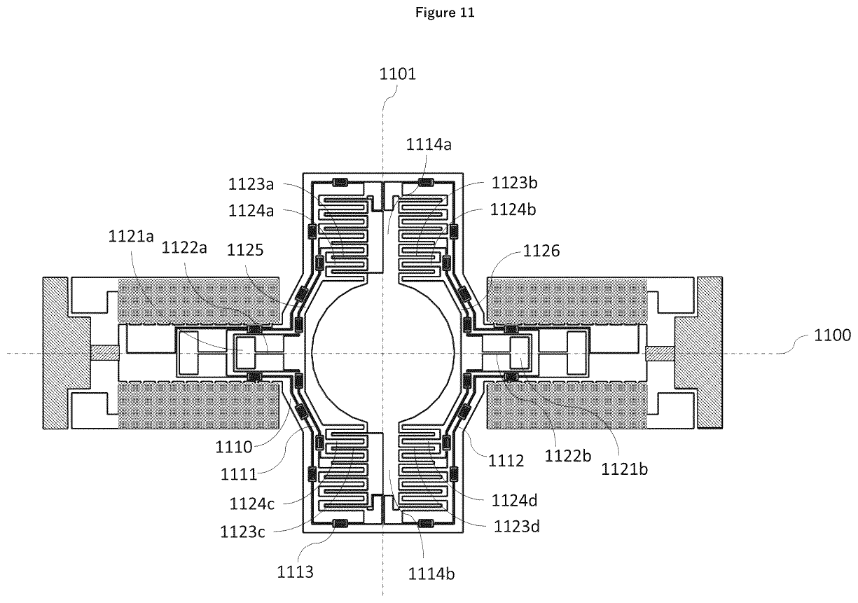

FIG. 11 shows another embodiment of the 2-dimensional tilting MEMS mirror with PRCH sensing implemented on one rotation axis and capacitive sensing implemented on the other axis. The structures shown in the figure are fabricated by highly doped Silicon (n or p). As shown in the figure, 1100 and 1101 are the first and second rotation axis of the MEMS mirror. Compared with the embodiment shown in FIG. 9, the major difference is that a secondary independent comb drive is designed as the capacitive sensor for the mirror tilting angle around second rotation axis. Extra sensing comb drives are placed besides the actuator comb drives of second rotation axis. 1123a, 1123b, 1123c, 1123d are the moveable combs for the sensing comb drives, which are coupled to the supporting beams 1114a and 1114b. 1124a, 1124b, 1124c, 1124d are the fixed combs for the sensing comb drive of axis 1101 which are coupled to the inner frames 1125 and 1126. The 1125 and 1126 are designed to give mechanical support and electrical connection to the fixed sensing combs 1124a, 1124b, 1124c, 1124d. 1125 is coupled to the flexure 1122a and then to fixed anchor electrode 1121a. 1126 is coupled to the flexure 1122b and then to fixed anchor electrode 1121b. 1122a and 1122b are situated on axis 1100 and there are bonding pads on the electrodes 1121a and 1121b. 1125 and 1126 are both electrically isolated but mechanically coupled to intermediary inner frame 1111 and 1112 with bonding structure 1113. 1113 is a bonding structure that is designed to mechanically bond but electrically isolate different parts. Capacitive sensing signal is detected from the electrodes 1121a, 1121b. Other than the independent inner sensing comb drives designed for second axis mirror angle sensing, the structures and driving, sensing mechanisms are identical to what is shown in the embodiment shown in FIG. 9.

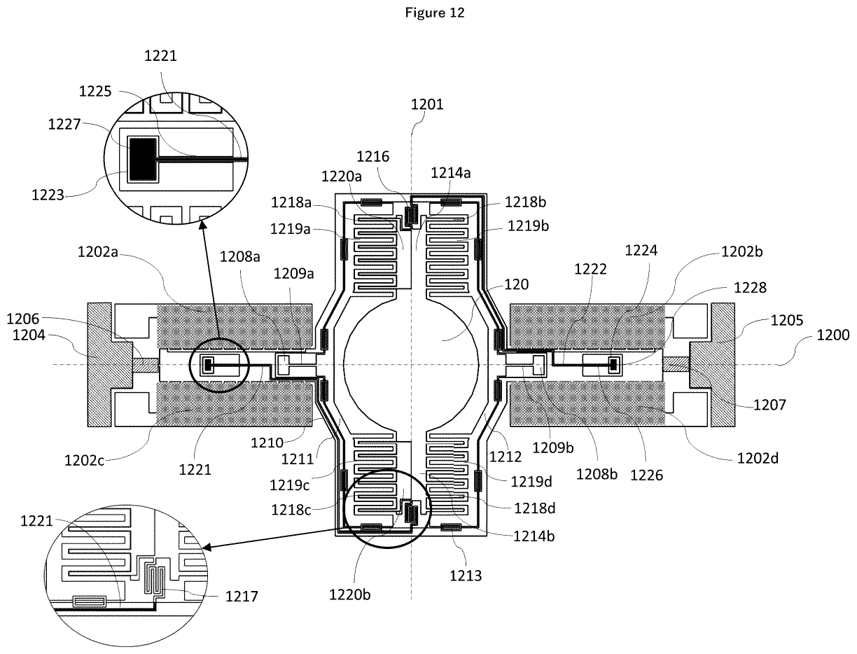

FIG. 12 shows an embodiment of the 2-dimensional tilting MEMS mirror with PRCH sensing implemented on both rotation axes. The structures shown in the figure are fabricated by highly doped Silicon (n or p). The design is based on a 2D gimbal structure with electrostatic actuators. There are two rotation axes for the mirror 120, which are the first rotation axis 1200 and the second rotation axis 1201. For the first axis 1200, the driving and sensing structures and operation mechanisms are identical with the 1D tiling MEMS mirror with PRCH sensing. Reference characters 1206 and 1207 are the flexures/piezo-resistors for mirror rotation and piezo-resistive angle sensing of axis 1200. The flexure/piezo-resistor design and piezo-resistor sensing mechanisms can be identical with either embodiment shown in FIG. 3, FIG. 5, FIG. 7. Reference characters 1204, 1205 are the fixed anchor electrode for piezo-resistors 1206 and 1207. The fixed anchor electrode design can be identical with either embodiment shown in FIG. 3, FIG. 5, FIG. 7. Reference characters 1202a, 1202b, 1202c, 1202d are driving and sensing comb drives for the axis 1200, which can be either staggered comb drive design or slanted comb drive design, independent or integrated sensing comb drive design as depicted in embodiment shown in FIG. 3, FIG. 5 and FIG. 8. Reference character 1210 is the frame that provide mechanical support to all movable parts rotating around axis 1200. The gimbal rotates along the second rotation axis 1201 which is imposed on frame 1210. Reference characters 1216, 1217 (in zoom-in view) are the flexures/piezo-resistors that support rotation around 1201 and piezo-resistive angle sensing. One end of piezo-resistors 1216, 1217 is coupled to frame 1210 and the other end is coupled to the supporting beam 1214a and 1214b for the rotation axis 1201. Supporting beams 1214a, 1214b are further coupled to the MEMS mirror 1201. The slanted comb drive is designed for the driving and capacitive sensing of the rotation axis 1201. Reference characters 1218a, 1218b, 1218c, 1218d are the movable comb drives for axis 1201 which are coupled to support beams 1214a and 1214b. An extra layer 1220a and 1220b are deposited on the top of comb 1218a and 1218c. Reference characters 1219a, 1219b, 1219c, 1219d are the fixed comb drives for axis 1201. Fixed comb drives 1219a, 1219c are coupled to the inner frame 1211 and fixed comb drives 1219b, 1219d are coupled to inner frame 1212 for different tilting direction. The frames 1211 and 1212 are designed to give mechanical support and electrical connection to the fixed comb drives 1219a, 1219b, 1219c, 1219d. Frame 1211 is coupled to the flexure 1209a and then to fixed anchor electrode 1208a. Frame 1212 is coupled to the flexure 1209b and then to fixed anchor electrode 1208b. 1209a and 1209b are situated on axis 1200 and there are bonding pads on the electrodes 1208a and 1208b. Frames 1211 and 1212 are both electrically isolated but mechanically coupled to frame 1210 with bonding structure 1213. Bonding structure 1213 is a bonding structure that is designed to mechanically combine but electrically isolate different parts. There are several bonding structures identical to 1213 placed between frames 1211 and 1210, 1212 and 1210, as shown in the figures. Mirror 1201, support beams 1214a, 1214b, and comb drives 1218a, 1218b, 1218c, 1218d form the movable part that rotates around rotation axis 1201 and the entire movable part is coupled to the frame 1210 through flexures 1216 and 1217. As the flexures 1216 and 1217 only support the mirror rotation around 1201 and restrict the rotation otherwise, the entire structure coupled to frame 1210 will follow the rotation of frame 1210 around axis 1201. At the same time, this movable part can also rotate around axis 1200 with frame 1210. Meanwhile, the movable part is electrically coupled to the common end through flexures 1216 and 1217. When driving signal is applied to electrodes 1208a, 1208b, this signal is transmitted to the fixed comb drives 1219a, 1219b, 1219c, 1219d through the flexure 1209a, 1209b and the inner frames 1211, 1212 as they are all made of conductively doped Silicon. The movable comb drives 1218a, 1218b, 1218c, 1218d are coupled to the common end which is connected to ground. The driving and capacitive sensing mechanism of the rotation axis 1201, based on the slanted comb drive, is identical to that described in the embodiment in FIG. 5. To implement piezo-resistive angle sensing for the rotation axis 1201, a pair of additional electrodes 1223, 1224 for piezo-resistive sensing are placed on axis 1200. The electrodes 1223 and 1224 are connected to the frame 1210 through flexure 1225 (in zoom-in view), 1226. Thus, electrodes 1223 and 1224 is connected to the common end. Reference character 1227 (in zoom-in view) is the metal bond pad deposited on the electrode 1223. A metal trace 1221 is deposited on flexure 1225, frame 1210 to connect the metal bond pad 1227 and flexure/piezo-resistor 1217. Reference character 1228 (in zoom-in view) is the metal bond pad deposited on the electrode 1224. A metal trace 1222 is deposited on flexure 1226, frame 1210 to connect the metal bond pad 1227 and flexure/piezo-resistor 1216. The metal traces are non-piezo-resistive material, and the structural deformation induced piezo-resistance variation of silicon will be minimized if the silicon structure is covered by the metal trace. The piezo-resistance change for the rotation axis 1201 can be measured from the bonding pads 1227 and 1228. The mirror rotation around the axes 1200 and 1201 are decoupled and does not interfere with each other during 2 axes rotation.

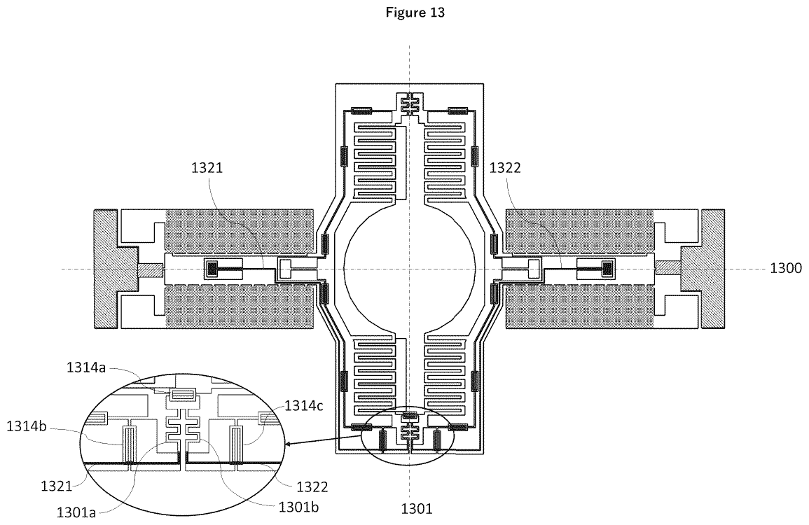

FIG. 13 shows an embodiment of the 2-dimensional tilting MEMS mirror with PRCH sensing implemented on both rotation axes. The structure design and the operation mechanism are identical with the embodiment shown in the FIG. 12, except for the design for the piezo-resistor for the angle sensing of axis 1301. A pair of parallel flexure/piezo-resistor design is used for sensing purpose. The structure for the vertical axis piezo-resistive angle sensing is detailed in the zoom-in view. Only single side of the flexure/piezo-resistor for second axis is used for the angle detection. Reference characters 1321 and 1322 are the metal traces connected the electrodes to the second axis sensing piezo-resistor element. Reference characters 1301a and 1301b are the flexures/piezo-resistors. The entire flexure/piezo-resistor is electrical isolated from the external frame (common end) but mechanically coupled to the frame with the bonding structures 1314a, 1314b, 1314c. The metal traces can be deposited on the bonding structures. Meanwhile, to avoid the electrical bridging of the piezo-resistor and the common end, the metal traces should be isolated from the common end.

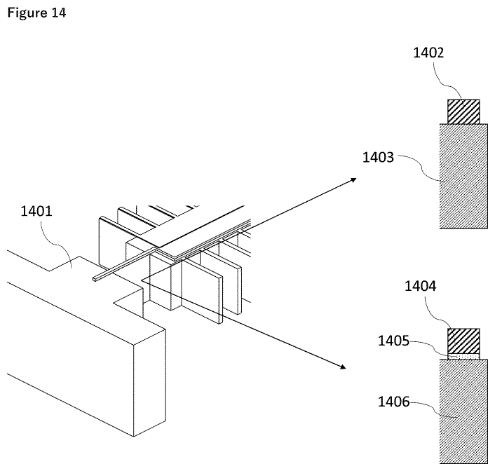

FIG. 14 shows the structure of the metal trace and metal bonding pad for the piezo-resistive sensing on the second rotation axis. 1401 is the electrode for the piezo-resistive angle sensing of second rotation axis. The metal trace and bonding deposited on the hinge, electrode and connection structure have two basic configurations as shown. In one configuration, 1402 is the deposited metal layer. 1403 is the bulk silicon. In this case, the metal layer shunts the connection of silicon. The metal layer reduces the piezo-resistance change of the silicon when deformation occurs. In another configuration, the 1404 is the metal layer, 1405 is an insulation layer and 1406 is the bulk silicon. The bonding pad and trace are completely insulated from the bulk silicon. If this schematic is used, the impact of the electrical coupling from silicon or resistance change due to unanticipated deformation can be eliminated. Both configurations can be adopted for the piezo-resistive angle sensing for the rotation around second axis for the embodiments in FIG. 12 and FIG. 13.

FIG. 15 shows the different embodiments of the piezo-resistor design with single electrode connected to mirror movable part. The 1501 is the fixed anchor electrode and 1502 is the MEMS mirror movable part. The flexure/piezo-resistor can be either a single beam design or multiple beam design. Reference characters 1503, 1504, 1505, 1506 are the embodiments for a single beam structure design. Reference characters 1507, 1508, 1509, 1510 are the embodiments for dual beam structure design. The resistance from fixed anchor electrode 1501 to the MEMS mirror movable part 1502 is defined by the profile of the beams such as beam width, beam length and material conductivity. The sensitivity of the piezo-resistor versus the rotation angle can be determined by the different shape of the designs.

FIG. 16 shows the different embodiments of the piezo-resistor design with multiple electrodes connected to mirror movable part. Reference characters 1601a, 1601b, 1601c are the fixed anchor electrodes and 1602 is the MEMS mirror movable part. In embodiments 1603a and 1603b are independent flexures/piezo-resistors connecting the different electrodes 1601a and 1601b to the MEMS mirror movable part 1602. When the mirror rotates, the flexures 1603a and 1603b deform at the same time. Thus, there are two piezo-resistors placed in parallel for the piezo-resistive sensing. 1604a, 1604b 1605a, 1605b shows the flexure examples with identical parallel piezo-resistor sensors. Asymmetric designs shown as 1606a and 1606b can be used as flexure/piezo-resistor as well. In this embodiment, the piezo-resistor can generate different response for different tilting directions. Reference characters 1607a, 1607b, 1607c are for the triple flexure/piezo-resistor design. All three flexures/piezo-resistors are independent and provide more flexibility for the piezo-sensing.

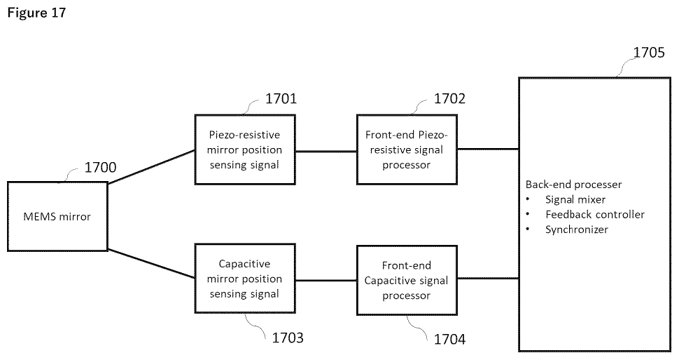

FIG. 17 shows an embodiment of the MEMS mirror application using PRCH sensing. The embodiment consists of MEMS mirror 1700, piezo-resistive mirror position sensing signal 1701, capacitive mirror position sensing signal 1703, front-end piezo-resistive signal processor 1702, front-end capacitive signal processor 1704 and back-end processer 1705. 1700 is the MEMS mirror that can generate the PRCH sensing signal indicating the mirror position during movement. 1701 is the piezo-resistive sensing signal generated by 1700 which is then processed by front end resistive signal processor 1702. Front end resistive signal processor 1702 is the front-end circuit that can convert the raw signal 1701 into digital format or other formats that can be interpreted by the back-end processer 1705. For one embodiment, the front end resistive signal processor 1702 is an independent circuitry connected to the MEMS mirror package. For another embodiment, front end resistive signal processor 1702 is an integrated circuit placed inside the same carrier material of 1700. For another embodiment, front end resistive signal processor 1702 is directly integrated with mirror 1700 through compatible fabrication process. On the other hand, mirror 1700 can also generate capacitive mirror position sensing signal 1703. capacitive mirror position sensing signal 1703 is then processed by front-end capacitive signal processor 1704 that can convert the raw signal 1703 into digital format or other formats that can be interpreted by the back-end processer 1705. For one embodiment, the front-end capacitive signal processor 1704 is an independent circuitry connected to the MEMS mirror package. For another embodiment, front-end capacitive signal processor 1704 is an integrated circuit placed inside the same carrier material of 1700. For another embodiment, front-end capacitive signal processor 1704 is directly integrated with 1700 through compatible fabrication process. The back-end processer 1705 is the back-end processor that converts voltage into mirror position data and sends out the angle related information to the other part of the system. In one embodiment, back-end processer 1705 is an integrated circuit that combines the signals of the PRCH sensors, calibrates voltage to position relation, and converts voltage to mirror position. back-end processer 1705 also generates signal used to adaptively tune the driving waveform of the MEMS mirror to maintain stable scanning performance. Back-end processer 1705 also generates synchronization signal for MEMS mirror position.

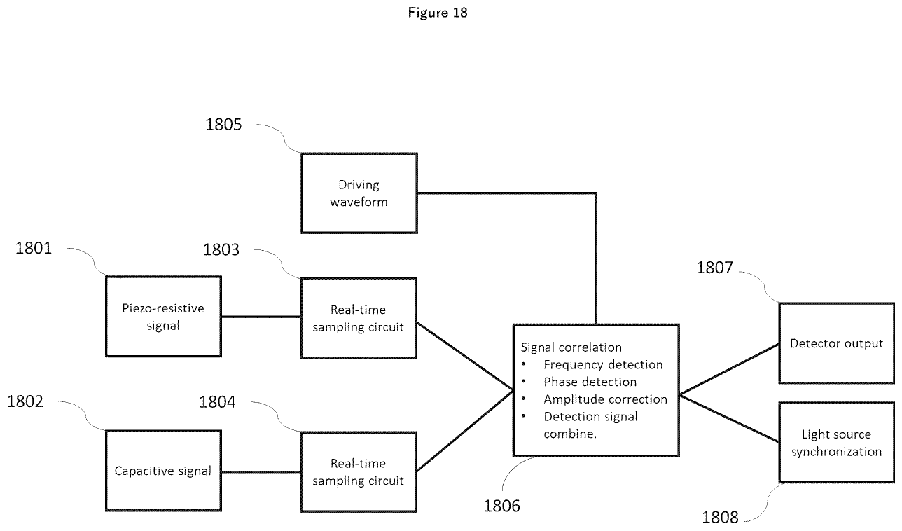

FIG. 18 is a diagram representing one embodiment for the post-processing of PRCH sensing signal for the MEMS mirror the piezo-resistive sensing signal 1801 and capacitive sensing signal 1802 is measured from the MEMS mirror. The signals are sampled simultaneously with the circuit 1803 and 1804. Circuit 1803 and 1804 can be an amplifier and analog-to-digital convertor circuit. The output from the circuit 1803 and 1804 are processed by the digital signal processing unit 1806, which is mostly used for signal correlation. The driving signal 1805 is also used for the correlation process. In the digital signal processing unit 1806, there are 4 major tasks occurring, frequency detection, phase detection, amplitude correction and detection signal compensation. For the frequency detection and phase detection, both the outputs form the piezo-resistive and capacitive sensing can be used in independent or differential way to derive the frequency and amplitude information. For the amplitude correction, the capacitive sensing and piezo-resistive sensing will have different correction relation from the signal to the mirror absolute tilting angle. This correction relation is preloaded in the system through additional calibration process. Signals from the piezo-resistive sensing and capacitive sensing can also be used in a complementary way. Generally, the piezo-resistive is more sensitive for large mirror tilting angle and capacitive sensing is more sensitive for the small tilting angle. Thus, these two different detection methods can be combined to achieve a high sensitivity for the entire mirror scanning range. After the signal processing, the feedback information will be transmitted to the detector output 1807 for mirror location and light source modulator 1808 for synchronization of light pulse and mirror position.

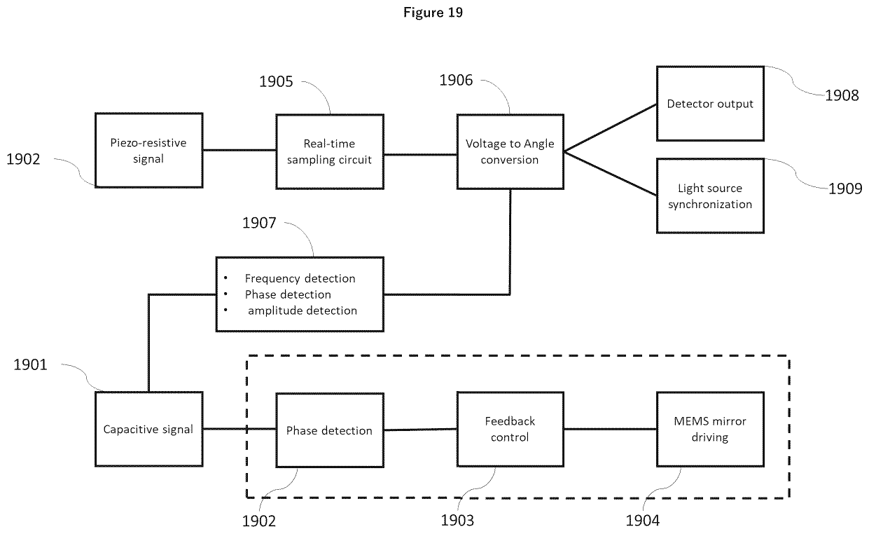

FIG. 19 is another diagram representing an embodiment for the post-processing of PRCH sensing signal for the MEMS mirror. Reference character 1901 is the capacitive sensing signal generated by the MEMS mirror. The capacitive sensing signal is used for both the MEMS mirror control and sensing. For the control, the phase of the capacitive sensing signal is extracted by phase detector 1902. The phase information is then used by a feedback control unit 1903 to generate the MEMS mirror driving signal which in turn is used to control the mirror scanning. This feedback control loop is phase-locked to achieve a consistent mirror scanning control. Meanwhile, the capacitive sensing signal is used to extract the mirror scanning frequency, phase and amplitude information 1907. On the other hand, piezo-resistive sensing signal 1902 is sampled by real-time sampling circuits 1905. Real-time sampling circuits 1905 can be an amplifier and analog-to-digital convertor circuit. The output from real-time sampling circuits 1905 is then processed by the digital signal processing unit 1906 to convert the voltage to angle with the preloaded calibration data. The conversion can be calibrated by the 1907 to increase the robustness of the sensing loop. The feedback information will be then transmitted to the detector output 1908 for mirror location and light source modulator 1909 for synchronization of light pulse and mirror position or any other relevant interface depending on the application.

1. A deflectable micro-mechanical system with integrated piezoresistive deflection sensor, the system comprising:
a deflectable element;
a first anchor element and a second anchor element;
a first spring having a deformable region and coupling the deflectable element to the first anchor element;
a second spring that having a deformable region and coupling the deflectable element to the second anchor element;
when the relative position of the deflectable element to the anchor element changes, the deformable region of the first spring and the deformable region on the second spring deform; and
at least one of the first spring and second spring are piezoresistive and the piezo-resistance of the piezoresistive springs changes when the deformable region of the first spring and the deformable region of the second spring deforms; and
wherein a first contact and a second contact are located on the first anchor element and second anchor element, respectively; the first contact in electrical connection with the first anchor element and the second contact in electrical connection with the second anchor element; the first contact and second contact electrically coupled to a resistance detection circuit configured to detect the overall piezo resistance change of the first spring and second spring and using the piezo resistance change to determine the deflection of the deflectable element.

2. The system of claim 1, wherein the first and second anchor element, deflectable element, first spring and second spring are made with identical material.

3. The system of claim 1, wherein the material is doped silicon.

4. The system of claim 1, wherein the first and second contacts are made with metal.

5. The system of claim 1, wherein the first spring and the second spring are partially covered with a layer of metal, the metal layer has good electrical contact with the material beneath.

6. The system of claim 5, wherein the metal deposition changes the overall resistance of the piezo-resistive springs.

7. The system of claim 5, wherein the metal deposition covers the regions on the spring with low piezo-resistance responsibility.

8. The system of claim 1, wherein the system is an indirect detection system for the measurement of force, pressure, acoustic signal, speed, acceleration, rotation rates.

9. The system of claim 1, wherein the deflectable element is a micro-stage that can carrier objects.

10. The system of claim 1, further consisting of at least one or more groups of anchor elements, contact and spring to support the deflectable element, wherein:
each of the additional springs connects the additional anchor element to the deflectable element;
the additional springs can be either piezoresistive or non-piezoresistive; and
the additional contact is situated on the anchor element.

11. The system of claim 10, wherein two or more piezoresistive springs can form a bridge sensor for deflection detection.

12. The system of claim 10, wherein the piezoresistive springs use identical material.

13. The system of claim 1, wherein the system makes a single axis gimbal structure and rotates along a first rotation axis. The springs are arranged along the first axis. At least one spring's geometry is non-centrosymmetric to the first rotation axis.

14. The system of claim 13, wherein the deflectable element is superimposed with a mirror or mechanically connected to a mirror.

15. The system of claim 13, wherein the deflectable element is mechanically connected to either an electrostatic actuator or a thermoelectric actuator or an electromagnetic actuator or a piezoelectric actuator.

16. The system of claim 13, wherein the configuration non-centrosymmetric is due to design layout sketching or fabrication process.

17. The system of claim 13, wherein the non-centrosymmetric piezo-resistive springs generate a opposite response when the mirror tilting clockwise or anti-clockwise from neutral position.

18. The system of claim 13, wherein the system is situated on a second deflectable platform that rotates along a second rotation axis which is not parallel to the first axis to make a two-dimensional gimbal.

19. The system of claim 18, wherein the system is a 2D tilting micromirror.

20. The system of claim 18, wherein the first axis is not a fixed axis but is moving with the rotation around the second axis.

21. The system of claim 13 further consisting of at least one or more groups of anchor elements, contact and spring to support the deflectable element, wherein:
each of the additional springs connects the additional anchor element to the deflectable element;
the additional springs can be either piezoresistive or non-piezoresistive; and
the additional contact is situated on the anchor element.

22. The system of claim 21, wherein two or more piezoresistive springs can form a bridge sensor for deflection detection.

23. The system of claim 21, wherein the piezoresistive springs are uniformly doped silicon.

24. The system of claim 1, wherein the piezo-resistive springs are formed with regions with 2 different doping concentrations levels which are first doping level region and second doping level region, amount which first doping level region has higher doping concentration than second doping level region.

25. The system of claim 24, wherein the first doping level region is within the deformable region of the piezo-resistive spring.

26. The system of claim 24, wherein the system makes a single axis gimbal structure and rotates along a first axis.

27. The system of claim 24, wherein the deflectable element is superimposed with a mirror or mechanically connected to a mirror.

28. The system of claim 24, wherein the deflectable element is mechanically connected to either an electrostatic actuator or a thermoelectric actuator or an electromagnetic actuator or a piezoelectric actuator.

29. The system of claim 24, wherein the first doping level region is on the surface of the piezo-resistive spring structures.

30. The system of claim 24, wherein the first doping level region overlaps with high stress region on piezo-resistive spring during deformation.

31. The system of claim 24, wherein the system is situated on a second deflectable platform that rotates along a second rotation axis which is not parallel to the first axis to make a two-dimensional gimbal.

32. The system of claim 31, wherein the system is a 2D tilting micromirror.

33. The system of claim 31, wherein the first axis moves with the rotation around the second axis.

34. The system of claim 24 further consisting of at least one or more groups of anchor elements, contact and spring to support the deflectable element, wherein:
each of the additional springs connects the additional anchor element to the deflectable element;
the additional springs can be either piezoresistive or non-piezoresistive; and
the additional contact is situated on the anchor element.

35. The system of claim 24, wherein two or more piezoresistive springs can form a bridge sensor for deflection detection.

36. A sensing system to detect the position of deflection of a deflectable micromechanical system comprising:
a deflectable system comprising
a deflectable element;
a transducer that converts the deflection of deflectable elements to capacitance signal; and
a transducer that converts the deflection of deflectable element to piezoresistive signal; and
resistive detection circuitry configured to:
convert capacitive sensing signal to a first electrical signal;
convert piezoresistive signal to a second electrical signal; and
process the first electrical signal and second electrical signal to calculate the deflectable element position.

37. The system of claim 36, wherein the system has a feature of sensing the temperature and compensating the impact of temperature variation.

38. The system of claim 36, wherein the circuitry is partially or fully integrated into an integrated circuit chip.

39. The system of claim 36, wherein the deflectable element has more than one dimension of movement, and there is plurality of capacitance transducers, piezoresistive transducers, and circuitry of detection to sense the deflection of each dimension.

40. The system of claim 36, wherein the deflectable system is a micro-stage which can hold optical components, optical detectors and optical light sources.

41. The system of claim 36, wherein the deflectable micromechanical system is a micromechanical mirror system.

42. The system of claim 41, wherein the micromechanical mirror is one of a tilting mirror, a mirror and a tilting mirror array.

43. The system of claim 41, wherein the micromechanical mirror is one of a translation mirror and a translation mirror array.
